(19) United States
(12) Patent Application Publication
(10) Pub. No.: US 2002/0170433 A1
(43) Pub. Date: Nov. 21, 2002

(54) Process and device for removing soot particles from diesel engine exhaust gas

(75) Inventors: Marcus Pfeifer, Solingen (DE); Harald Krieg, Frankfurt (DE); Barry van Setten, Rodenbach (DE); Roger Staab, Freigericht (DE); Jurgen Gieshoff, Biebergemund (DE); Egbert Lox, Hanau (DE); Thomas Kreuzer, Karben (DE)

Correspondence Address: KALOW & SPRINGUT LLP, 488 MADISON AVENUE, 19TH FLOOR, NEW YORK, NY, 10022, US

(73) Assignee: OMG AG & Co. KG, Hanau (DE)

(21) Appl. No.: 10/123,972

(22) Filed: Apr. 17, 2002

(30) Foreign Application Priority Data
Apr. 18, 2001 (EP) 01109571.8

(51) Int. Cl. B01D 53/00; B01D 46/00

(52) U.S. Cl. 95/285; 423/215.5; 422/168; 422/177; 422/180; 422/182; 422/183

(57) ABSTRACT

The invention provides a process for removing soot particles from exhaust gas from produced by a diesel engine. The process uses a particle filter that collects soot particles with the aid of nitrogen dioxide which is generated by catalytic oxidation of nitrogen monoxide contained in the exhaust gas. The process is characterized in that the particle filter is a deep-bed particle filter, having a filtration efficiency for the soot particles. The particle filter is coated with a catalytic coating for oxidizing nitrogen monoxide to nitrogen dioxide and the exhaust gas leaving the particle filter subsequently filtered through a particle filter serving as a soot barrier. The filter can have a filtration efficiency of over 95%.

### FIELD OF THE INVENTION

The invention provides a process and a device for removing soot particles from the exhaust gas from a diesel engine.

### BACKGROUND OF THE INVENTION

To protect the environment, new developments in the area of diesel vehicles are aimed at the simultaneous reduction of nitrogen oxides and soot emissions from diesel engines.

The problem with diesel engines is that they do not have the capability to reduce both nitrogen oxides and soot emissions simultaneously. When design steps are taken to lower the amount of one of the harmful components mentioned in diesel engines, the amount of the other harmful component is simultaneously raised. For example, when the soot emissions are lowered by increasing the combustion temperatures in a diesel engine, increased production of nitrogen oxides then takes place. In another example, when nitrogen oxide emissions are reduced, for example by recycling the exhaust gas, soot emissions increase.

The design steps taken to optimize diesel engines thus form a compromise between optimizing soot emissions and optimizing nitrogen oxide emissions.

To eliminate soot emissions, post treatment of the exhaust gas is required. For this purpose, filters, in particular wall-flow filters, are currently used to filter out the soot particles contained in the exhaust gas. Using these types of filters, degrees of filtering of more than 95% are obtained, so an efficient reduction in soot emissions in the exhaust gas from diesel engines is ensured. However, these types of filters become clogged due to the continuous deposition of soot particles. Therefore, the filters have to be regenerated by combustion of the soot particles.

In principle, regeneration of the filter can be achieved by thermal processes. The soot particles are then burnt with the aid of the oxygen present in the exhaust gas. The disadvantage with this, however, is that temperatures in the range 550° C. to 600° C. are required for these types of combustion processes.

However, these types of temperatures are obtained in the exhaust gas from a diesel engine only when the diesel engine is operating under full load. Regeneration of the filter under normal operation is possible only when the filter is heated by means of an additional heating element. This involves an increased energy demand, however, and thus also increased consumption of fuel.

It is known in the art that catalytic processes for regenerating filters are used instead of thermal processes. For example, the exhaust gas from a diesel engine is passed over a catalyst, in a first process step, without being filtered. By means of the catalyst, which preferably comprises a platinum group metal located on a honeycomb monolith, the nitrogen monoxide present in the exhaust gas is converted to nitrogen dioxide. A filter for filtering soot particles from the exhaust gas is arranged downstream of the catalyst. Nitrogen dioxide produced in the catalyst is used to regenerate the filter, in order to burn soot particles deposited on the filter at a temperature of less than 400° C. The problem with this process, however, is that amounts of nitrogen dioxide sufficient for complete regeneration of the filter are required.

Some modern diesel engines which have exhaust gas recycling systems, are optimized with regard to the emissions of nitrogen oxides so the amounts of nitrogen dioxide present in the exhaust gas is not sufficient for complete regeneration of the filter. Typically, combustion of only 50% to 70% of the soot particles is achieved with these types of diesel engines.

It has been suggested that an apparatus for eliminating soot particles from the exhaust gas stream of a diesel engine be comprised of a plurality of diesel particle filters arranged in series with each other and a plurality of oxidation catalysts arranged upstream of each particle filter.

The multiple arrangement of oxidation catalyst and particle filter allows for the multiple oxidation of nitrogen monoxide to nitrogen dioxide and subsequent reduction to nitrogen monoxide again in the downstream filter while burning the collected soot at the same time. For example, an apparatus comprising four oxidation catalysts and four particle filters whereby the pore diameter of each downstream filter is smaller than that of the neighboured upstream filter. The apparatus is terminated by a wall flow filter with high degree of filtration.

It has also been proposed for removing soot particles from the exhaust gas from a diesel engine to use an arrangement multiple treatment units in sequence where each unit is comprised of an oxidation catalyst and a particle filter. The treatment units are made in such a way that only a certain proportion of the soot particles from the exhaust gas is deposited on the filter and that this can be burnt using the nitrogen dioxide produced in the associated catalyst in order to regenerate the filter.

In one design, the treatment units can be made in such a way that the relevant filter and the associated catalyst form an integral component. This type of component can be formed in particular from a filter, in particular a deep-bed particle filter, which is coated with the relevant catalyst.

The disadvantage of the last two processes is the relatively large expenses for the necessary number of treatment units. It is known in the art that the number of process stages chosen depends on the particular operating conditions of the diesel engine. The preferred number of 2 to 4 process steps cited is thus a compromise which is recommended as adequate for the particular operating conditions. It follows from this that, for complete removal of soot particles and, simultaneously, complete filter regeneration, a considerable number of treatment units is required. The cost to remove soot particles from the exhaust gas stream is thus undesirably high.

Based on the forgoing there is a need in the art for a process and a device which is relatively simple and allows the efficient and substantially complete elimination of soot particles from the exhaust gas from a diesel engine.

### SUMMARY OF THE INVENTION

The present invention provides a process for removing soot particles from the exhaust gas from a diesel engine using a particle filter and continuous combustion of the soot particles collected on the filter with the aid of nitrogen dioxide which is generated by catalytic oxidation of nitrogen monoxide contained in the exhaust gas. The process comprises using a deep-bed particle filter where the deep-bed particle filter has a filtration efficiency for the soot particles and is coated with a catalytic coating for oxidizing nitrogen monoxide to nitrogen dioxide and the exhaust gas having left the particle filter is led subsequently through a further particle filter, serving as a soot barrier and having a filtration efficiency of over 95%.

### BRIEF DESCRIPTION OF THE FIGURES

Preferred embodiments of the invention have been chosen for purposes of illustration and description, but are not intended in any way to restrict the scope of the invention. The preferred embodiments of certain aspects of the invention are shown in the accompanying figures, wherein:

FIG. 1 illustrates a schematic diagram of a first working example of the apparatus for removing soot particles from the exhaust gas from a diesel engine.

FIG. 2 illustrates a schematic diagram of a second working example of the apparatus for removing soot particles from the exhaust gas from a diesel engine.

### DETAILED DESCRIPTION OF THE INVENTION

The invention will now be described in connection with preferred embodiments. These embodiments are presented to aid in an understanding of the present invention and are not intended to, and should not be construed to, limit the invention in any way. All alternatives, modifications and equivalents which may become obvious to those of ordinary skill on reading the disclosure are included within the spirit and scope of the present invention.

This disclosure is not a primer on methods for removing soot particles from exhaust gas from a diesel engine, basic concepts known to those skilled in the art have not been set forth in detail.

The present invention includes a deep-bed particle filter. A deep-bed particle filter is a filtering device which collects the soot particles within the whole volume of the filter. It may include ceramic fibres, ceramic foams, wire meshes or similar structures. In general a deep-bed particle filter comprises a large pore material which removes the soot particles from the exhaust gas mainly by inertia and/or diffusion effects. Contrary to deep-bed particle filters the so-called wall-flow filters collect the soot particles on the surface of the filter material.

According to the present invention, nitrogen monoxide is oxidized to nitrogen dioxide. Nitrogen dioxide burns the soot particles deposited on the filter and gets reduced back to nitrogen monoxide which is then again oxidized to nitrogen dioxide and so forth. Thus, nitrogen monoxide is continuously recycled while flowing through the deep-bed particle filter. One such cycle will be called catalytic cycle in the following. Due to this recycling of nitrogen monoxide a relatively low concentration of nitrogen monoxide in the exhaust gas is sufficient for continuous combustion of all soot particles collected within the deep-bed particle filter.

For avoiding residual soot emission a second particle filter with a filtration efficiency of more than 95% is placed behind the deep-bed particle filter and performs the function of a so-called soot barrier. The filtration efficiency of a particle filter is understood to be the ratio of the particle mass collected by the filter with respect to the total particle mass carried into the filter by the exhaust gas. Deep-bed particle filter tend to reentrainement of the collected soot particles into the exhaust gas stream at sudden pressure changes. The soot barrier is intended to prevent sudden soot emissions at the occasion of pressure changes in the exhaust gas.

It is essential for the process according to the invention that the nitrogen monoxide contained in the exhaust gas is oxidized in multiple cycles to nitrogen dioxide and then reduced back to nitrogen monoxide by reaction with the collected soot. Thus, such a catalytic cycle includes the following reactions:

Oxidation of NO to NO₂:

NO+½O₂→NO₂ (1)

Combustion of soot and reduction of NO₂ to NO:

C+2NO₂→CO₂+2NO (2)

The catalytic cycle, which includes the two reactions (1) and (2), is passed through multiple times while the exhaust gas is traversing the deep-bed particle filter and thereby regenerates the deep-bed particle filter continuously.

The deep-bed particle filter and the catalyst, which is preferably applied to the deep-bed particle filter as a catalytic coating, can be tuned to one another in such a way that the described catalytic cycles prevent the filter from getting blocked by soot. For this purpose the filtration efficiency of the deep-bed particle filter has a value between 10 and 95%, preferably between 50 and 80%.

The number of catalytic cycles proceeding depends in particular by the process temperatures. For catalytic oxidation of nitrogen monoxide to nitrogen dioxide and for combustion of soot with the aid of the formed nitrogen dioxide a minimum exhaust gas temperature of 200° C. is necessary. Preferably the temperature in the region of the deep-bed particle filter lies between 350 and 450° C.

Due to the combined filter effect and continuous regeneration process, most of the soot particles present in the exhaust gas are eliminated within the deep-bed particle filter. The residual soot particles present at the exit from the deep-bed particle filter are collected on the soot barrier which is located after the deep-bed particle filter and is formed, for example, by a wall-flow filter or a sintered metal plate.

The residual soot particles deposited on the soot barrier are also continuously removed, preferably with the aid of the nitrogen dioxide produced in the deep-bed particle filter.

Having now generally described the invention, the same may be more readily understood through the following references to the following examples, which are provided by way of illustration and are not intended to limit the present invention unless specified.

### EXAMPLES

The examples are working example of the device according to the invention for removing soot particles from the exhaust gas from a diesel engine.

### Example 1

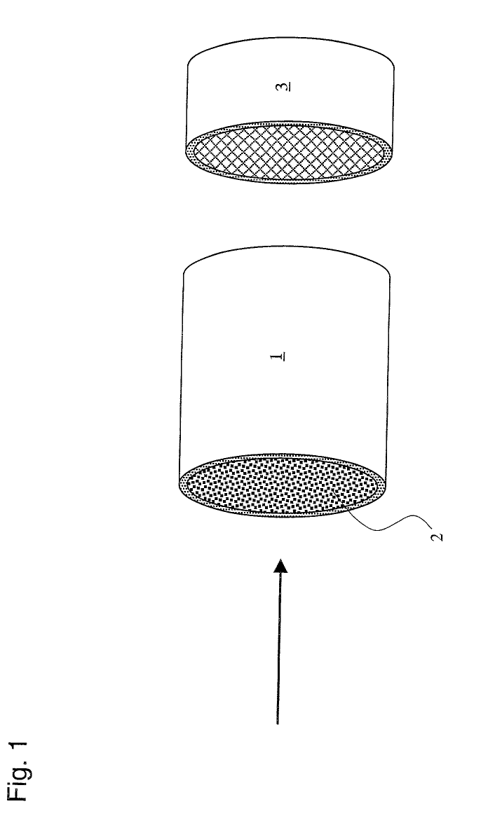

FIG. 1 shows a working example of the device according to the invention for removing soot particles from the exhaust gas from a diesel engine. The device has a deep-bed particle filter 1 with a catalyst, wherein the catalyst is applied to deep-bed particle filter 1 as catalytically active coating 2. In principle, the catalyst may also form the filter material in deep-bed particle filter 1 itself. The device also has a soot barrier 3. Soot barrier 3 is located in the exhaust gas stream of the diesel engine, marked with an arrow, downstream of deep-bed particle filter 1. In the present working example, soot barrier 3 consists of a wall-flow filter.

Deep-bed particle filter 1 comprises ceramic fibres, expanded ceramic material, wire mesh or the like. In general, deep-bed particle filter 1 comprises a coarse-pored filter material in which soot particles from the exhaust gas stream are deposited, mainly due to inertia effects and/or diffusion effects.

Catalytic coating 2 is expediently applied over the entire length of deep-bed particle filter 1. In addition, in principle, at least localized catalytic coating structures may also be provided at the inlet and outlet faces of deep-bed particle filter 1.

The cross-section of deep-bed particle filter 1 is fitted to the cross-section of the downstream wall-flow filter so that the entire exhaust gas stream at the outlet from deep-bed particle filter 1 is supplied to the wall-flow filter. In principle, the wall-flow filter may also be mounted on the outlet face of deep-bed particle filter 1.

Catalytic coating 2 has at least one noble metal, wherein in the present case catalytic coating 2 contains platinum. Furthermore, catalytic coating 2 contains at least one oxidic support material, in the present case aluminium oxide, onto which the noble metal is deposited. The catalyst in catalytic coating 2 can expediently contain an active substance which supports the oxidation of soot particles by decreasing the soot ignition temperature. Cerium oxide and/or zirconium oxide and/or terbium oxide and/or praseodymium oxide in particular can be used as these types of substances. As a result of the catalytic cycle, sufficient nitrogen dioxide is provided to extend to complete oxidation of the deposited soot particles and thus to regeneration of deep-bed particle filter 1.

Due to the filter effect of deep-bed particle filter 1, it is also ensured that the majority of the soot particles are filtered out of the exhaust gas stream. The remaining residual soot particles are deposited in soot barrier 3. Continuous oxidation of the deposited soot particles also takes place in soot barrier 3, wherein excess nitrogen dioxide generated in deep-bed particle filter 1 is preferably used for this purpose.

### Example 2

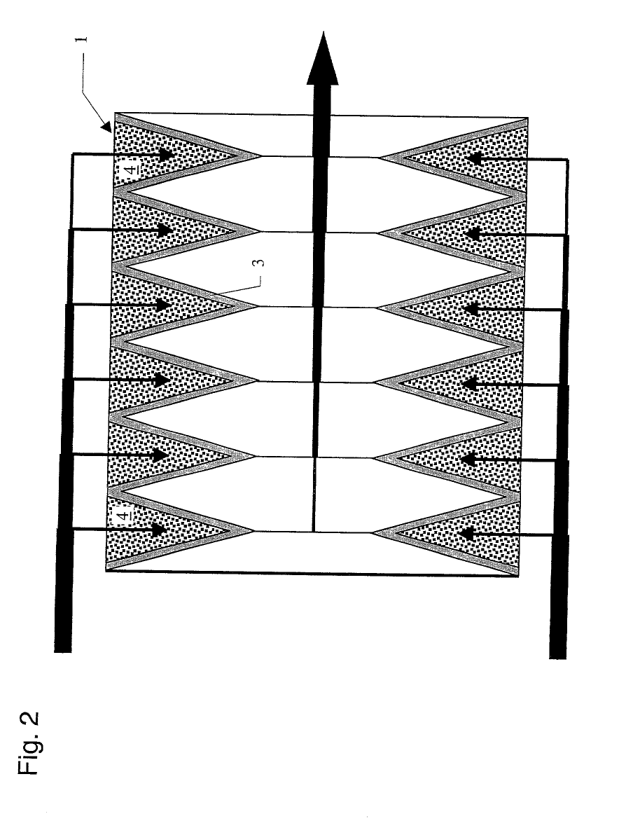

FIG. 2 shows a second working example of the device for removing soot particles from the exhaust gas from a diesel engine. The device, and in particular deep-bed particle filter 1, in this case has substantially the shape of a hollow cylinder. The direction of flow of the exhaust gas stream in FIG. 2 is again represented by arrows. The external casing surface of the hollow cylinder forms the inflow face of deep-bed particle filter 1, via which the exhaust gas is supplied to deep-bed particle filter 1. After flowing through deep-bed particle filter 1 and the soot barrier 3 located downstream of this, the exhaust gas stream is discharged via the central discharge channel running in the longitudinal direction of the hollow cylinder.

The filter material in deep-bed particle filter 1 preferably corresponds to the filter material in accordance with the working example shown in FIG. 1. The catalyst material in the catalytic coating 2 applied to deep-bed particle filter 1 also corresponds to that in the working example shown in FIG. 1.

The deep-bed particle filter 1 in accordance with FIG. 2 consists of an arrangement of several identically designed filter elements 4. Filter elements 4 are designed to be substantially circular in shape and run round in the direction of the periphery of the hollow cylinder. Filter elements 4 follow closely after each other in the longitudinal direction of the hollow cylinder so that the rear faces of filter elements 4 form a closed surface which forms the external surface of the hollow cylinder and thus the inflow face of deep-bed particle filter 1. The individual filter elements 4 contain the catalyst which is distributed over the entire volume of each filter element 4. Each filter element 4 has a triangular cross-section. A sintered metal plate is applied, as soot barrier 3, to the side faces of each filter element 4, thus forming sharp angled elements projecting into the discharge channel.

The exhaust gas is supplied via the inflow faces of deep-bed particle filter 1 of the individual filter elements 4. The catalyst in filter element 4 is used, in the same way as in the working example shown in FIG. 1, to oxidize the nitrogen monoxide contained in the exhaust gas. Thus, a plurality of catalytic cycles for the continuous removal of soot particles from the exhaust gas stream is again established within filter elements 4.

The deposition of residual soot particles again takes place in soot barrier 3. It is particularly advantageous here that the catalyst in filter element 4 is immediately adjacent to soot barrier 3. A large contact area with the catalyst is produced due to the two-dimensional design of soot barrier 3. This ensures that nitrogen dioxide generated in the catalyst is also available in soot barrier 3 in amounts sufficient to oxidize the soot particles.

While the invention has been described in connection with specific embodiments thereof, it will be understood that it is capable of further modifications and this application is intended to cover any variations, uses, or adaptations of the invention following, in general, the principles of the invention and including such departures from the present disclosure as come with the known or customary practice within the art to which the invention pertains and as may be applied to the essential features hereinbefore set forth and as follows in the scope of the appended claims.

What is claimed:

1. A process for producing substantially soot-free exhaust gas from a diesel engine comprising:
a. filtering an exhaust gas containing soot particles using a deep-bed particle filter to provide an initially filtered exhaust gas, wherein the deep-bed particle filter has a filtration efficiency for soot particles and is coated with a catalytic coating for oxidizing nitrogen monoxide to nitrogen dioxide;
b. continuously combusting the soot particles collected on the deep-bed particle filter using nitrogen dioxide, which is generated by catalytic oxidation of nitrogen monoxide contained in the exhaust gas and is reduced back to nitrogen monoxide by combusting the soot particles, whereby the process of oxidizing and reducing of nitrogen monoxide is continuously repeated while the exhaust gas is passing the filter; and
c. further filtering the initially filtered exhaust gas from the deep-bed particle filter through a second particle filter, wherein the second particle filter serves as a soot barrier, has a filtration efficiency of at least 10% to produce a substantially soot-free exhaust gas.

2. A process according to claim 1, wherein the deep-bed particle filter has a filtration efficiency between about 10 and 95%.

3. A process according to claim 2, wherein the deep-bed particle filter has a filtration efficiency between about 50 and 80%.

4. A process according to claim 3, wherein the soot barrier has a filtration efficiency of more than about 98%.

5. A device for removing soot particles from an exhaust gas from a diesel engine comprising a deep-bed particle filter, the filter coated with a catalytic coating for the oxidation of nitrogen monoxide to nitrogen dioxide; and a second particle filter with a filtration efficiency of greater than 95%, wherein the second particle filter is downstream from the deep-bed particle filter and forms a soot barrier.

6. A device according to claim 5, wherein the deep-bed particle filter is made from a material selected from the group consisting of ceramic fibres, expanded ceramic material or wire mesh.

7. A device according to claim 6, wherein the catalytic coating contains at least one noble metal.

8. A device according to claim 7, wherein the catalytic coating contains platinum.

9. A device according to claim 7, wherein the catalytic coating contains at least one oxidic support material for each noble metal.

10. A device according to claim 9, wherein each oxidic support material is formed from aluminium oxide.

11. A device according to claim 5, wherein the catalytic coating further contains a material selected from the group consisting of cerium oxide, zirconium oxide, terbium oxide, praseodymium oxide and mixtures thereof.

12. A device according to claim 5, wherein the soot barrier is formed from a wall-flow filter located downstream of the deep-bed particle filter.

13. A device according to claim 5, wherein the soot barrier is formed from a metal sinter.

14. A device according to claim 13, wherein the deep-bed particle filter further comprises a plurality of arranged parallel filter elements containing the catalyst, through which the exhaust gas flows, wherein the filter elements have arranged sintered metal plates on an outflow face.

15. A process for producing substantially soot-free exhaust gas from a diesel engine by continuous combustion of the soot particles collected by a particle filter with the aid of nitrogen dioxide which is produced by catalytic oxidation of nitrogen monoxide contained in the exhaust gas, the improvement comprising:
a. filtering the exhaust gas containing soot particles using a deep-bed particle filter to provide an initially filtered exhaust gas, wherein the deep-bed particle filter has a filtration efficiency for soot particles and is coated with a catalytic coating for oxidizing nitrogen monoxide to nitrogen dioxide;
b. continuously combusting the soot particles collected within the deep-bed particle filter with the aid of nitrogen dioxide obtained by oxidizing the nitrogen monoxide contained in the exhaust gas at the catalytic coating of the filter and reducing the nitrogen dioxide back to nitrogen monoxide while combusting the soot particles, whereby the process of oxidizing and reducing of nitrogen monoxide is continuously repeated while the exhaust gas is passing the filter; and
c. further filtering the initially filtered exhaust gas from the deep-bed particle filter through a second particle filter, wherein the second particle filter serves as a soot barrier, has a filtration efficiency of at least 10% to produce a substantially soot-free exhaust gas.
